(19) United States
(12) Patent Application Publication
(10) Pub. No.: US 2007/0158951 A1
(43) Pub. Date: Jul. 12, 2007

(54) Lock for the multiple locking of doors or wall sections in housings of cabinets

(76) Inventors: Dieter Ramsauer, Schwelm (DE); Rainer Bretschneider, Lommatzsch (DE); Lars Gallasch, Loethain (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/582,205

(22) PCT Filed: Dec. 10, 2004
(86) PCT No.: PCT/EP04/13694

§ 371 Date: Jun. 8, 2006

(30) Foreign Application Priority Data
Dec. 10, 2003 (DE) 20319136.6

(51) Int. Cl. E05C 9/12

(52) U.S. Cl. 292/39

(57) ABSTRACT

The invention is directed to a fastener for multiple locking of doors or wall portions in housings or cabinets, particularly for outdoor use, by means of a lockable actuation member such as a handle lever, comprising a drive toothed wheel which is connected to the actuation member supported in the door so as to be rigid against rotation and which engages with a lock rod which is supported in the door so as to be displaceable axially and which has teeth on at least one side, and with lock elements which are held in the door so as to be rotatable or swivelable and which are coupled with the lock rod. According to the invention, for each lock element, a driven toothed wheel which is connected to the lock elements so as to be rigid against rotation and which engages with the teeth of the lock rod is held on the door in a rotatable manner in order to couple the lock rod with the lock elements.

### CROSS-REFERENCE TO RELATED APPLICATIONS

This application claims priority of International Application No. PCT/EP2004/013694, filed Dec. 2, 2004 and German Application No. 203 19 136.6, filed Dec. 10, 2003, the complete disclosures of which are hereby incorporated by reference.

### BACKGROUND OF THE INVENTION

a) Field of the Invention

The invention is directed to a fastener for multiple locking of doors or wall portions in housings or cabinets, particularly for outdoor use, by means of a lockable actuation member such as a handle lever, comprising a drive toothed wheel which is connected to the actuation member that is supported in the door so as to be rigid against rotation and which engages with a lock rod which is supported in the door so as to be displaceable axially and which has teeth on at least one side, and with one or more lock elements which is/are held in the door so as to be rotatable or swivelable and which is/are coupled with the lock rod.

b) Description of the Related Art

U.S. Pat. No. 4,631,937 discloses a fastener arrangement for a cabinet door in which the locking process is carried out by means of a lockable actuation member such as a handle lever and which comprises a drive toothed wheel which is connected to the actuation member supported in the door so as to be rigid against rotation and which engages with a lock rod which is supported in the door so as to be displaceable axially and which has teeth on at least one side. However, the appearance of the lock elements which are to be actuated by the rod is not disclosed.

U.S. Pat. No. 4,747,628 discloses a locking arrangement for a strong box (safe) in which a locking rod having teeth on both sides is driven on one side by a toothed wheel that is actuated by a handwheel, while the other toothing drives a plurality of gear-shaped lock elements. Since the toothed wheel itself forms the lock element, its diameter must be very large. Neither a stop bevel nor a pull-in movement is provided. Consequently, the construction of this safe fastener is not suitable for cabinets with sealing strips. Therefore, it is not intended for outdoor use.

Also known to the present applicant is a construction in which a toothed locking rod that is driven by a toothed wheel of an actuation member drives lever-shaped lock elements which are articulated at the rod and which are held in the door so as to be swivelable. The space required for the lever articulation is disadvantageous.

### OBJECT AND SUMMARY OF THE INVENTION

It is the primary object of the invention to improve a fastener of the type mentioned above in such a way that it can be accommodated in a space-saving manner, enables a tightening or pull-in movement of the door and, therefore, sealing, and can be safeguarded against unwanted opening in a particularly reliable manner.

The above-stated object is met in that, for each lock element, a drive toothed wheel which is connected to the lock element so as to be rigid against rotation and which engages with the toothing of the lock rod is held on the door in a rotatable manner in order to couple the lock rod with the lock element or lock elements.

In this way, doors or lids having a plurality of lock elements enabling a pull-in movement can be closed, and the lock elements can be actuated in a space-saving manner by means of a central, lockable operating element. In particular, this type of fastener can be applied wherever high closing force must be overcome or long closing paths must be implemented when using corresponding sealing systems for protecting against weather, water and dust and/or electromagnetic shielding and wherever it is very important to prevent attempts at unauthorized opening.

In particular, a construction is made possible which is substantially narrower and better protected than is the case in a lever-type drive for the lock element.

In order to further economize on space it is advantageous, according to a further development of the invention, when the lock rod which is supported so as to be displaceable axially is guided in one or more separate metal guide parts or plastic guide parts. This offers the additional advantage that the arrangement operates more smoothly. This can also be achieved or enhanced by coating the guide parts with sliding agents.

It is particularly advantageous according to another construction of the invention when the lock rod which is supported so as to be displaceable axially is guided in an elongated metal profile or plastic profile. This provides excellent protection against external influences.

The compactness of the system is also benefited in an embodiment form of the invention in which a fastener lock is arranged on the toothed wheel (the driven toothed wheel and, optionally, the drive toothed wheel) so as to be rigid against rotation.

The fastener lock can comprise a bent and/or shaped sheet-metal lug which can be swiveled in behind a housing contour or cabinet frame contour by rotation.

In an even more advantageous manner, the fastener lock can also comprise a shaped or injection-molded plastic lug or metal lug which can be swiveled in behind a housing contour or cabinet frame contour by rotation.

It is also particularly advantageous when the fastener lock comprises a metal carrier part such as bent and/or shaped sheet-metal lugs or injection-molded plastic lugs or metal lugs on which a shaped part made of plastic or another material with favorable sliding properties is arranged and which can be swiveled in behind a housing contour or cabinet frame contour by rotation.

It has proven particularly favorable when the metal profile or plastic profile has a substantially U-shaped cross section which encloses the lock rod and toothed wheel and which increases protection against weather and tampering.

The U-shaped profile can be closed by a cover that can be arranged thereon, which further increases protection against dust, weather and attempts at tampering.

The actuation member advantageously comprises a swivel lever that can be folded into a trough arranged on the door.

For improved security against unauthorized attempts at opening, the trough advantageously comprises saw-proofing protection.

This saw-proofing protection can also be retrofitted into the inner contour of the trough. The saw-proofing protection is further improved in that the part that can be fitted subsequently is rotatably mounted.

It is advantageous when the trough comprises a lettering surface for displaying the rotating direction or other writing and/or symbols such as company logos. This type of lettering can be made particularly weatherproof.

For security reasons it is also advantageous when the trough has shallow sloping outer side walls that are difficult to grasp with gripping tools.

### BRIEF DESCRIPTION OF THE DRAWINGS

The invention will be explained more fully in the following with reference to embodiment examples shown in the drawings.

FIG. 1 is an exploded, perspective view showing an embodiment form of the present invention from the back;

FIG. 2 is a side view showing an embodiment form for a possible toothed rod;

FIG. 3 is a cross-sectional view through the embodiment form according to the invention shown in FIG. 1;

FIGS. 4A and 4B are perspective views from the front and back of the toothed wheel engaging in the toothed rod;

FIG. 5 is a rear view of a portion of the fastener according to the invention; and

FIGS. 6A, 6B and 6C show three different views of a particularly advantageously designed drive lever for the fastener according to the invention.

### DESCRIPTION OF THE PREFERRED EMBODIMENTS

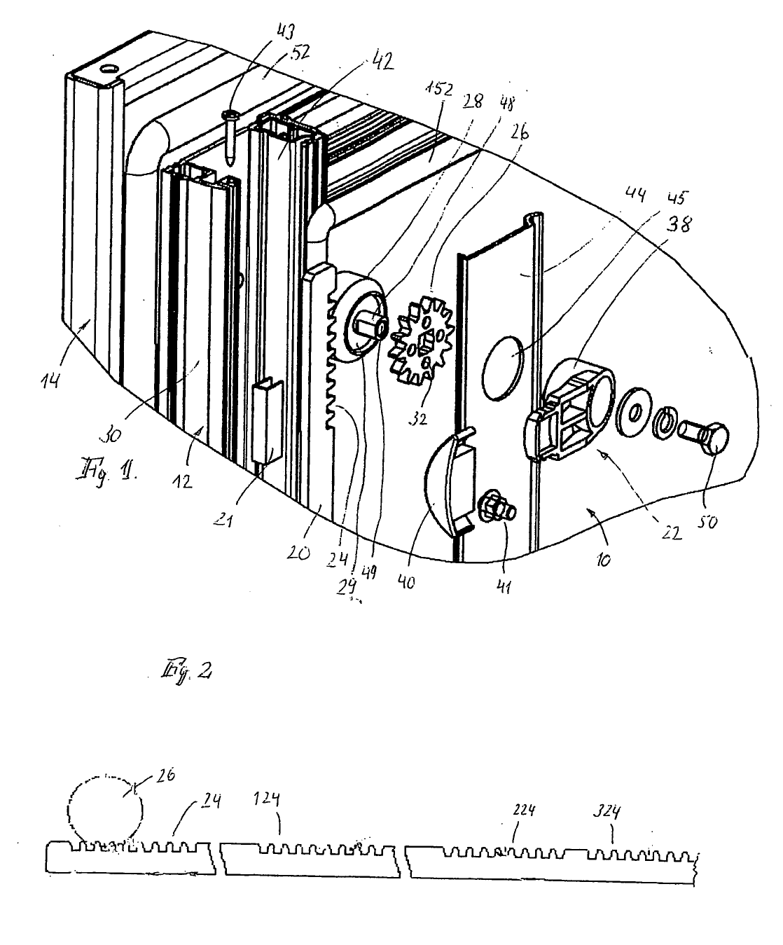

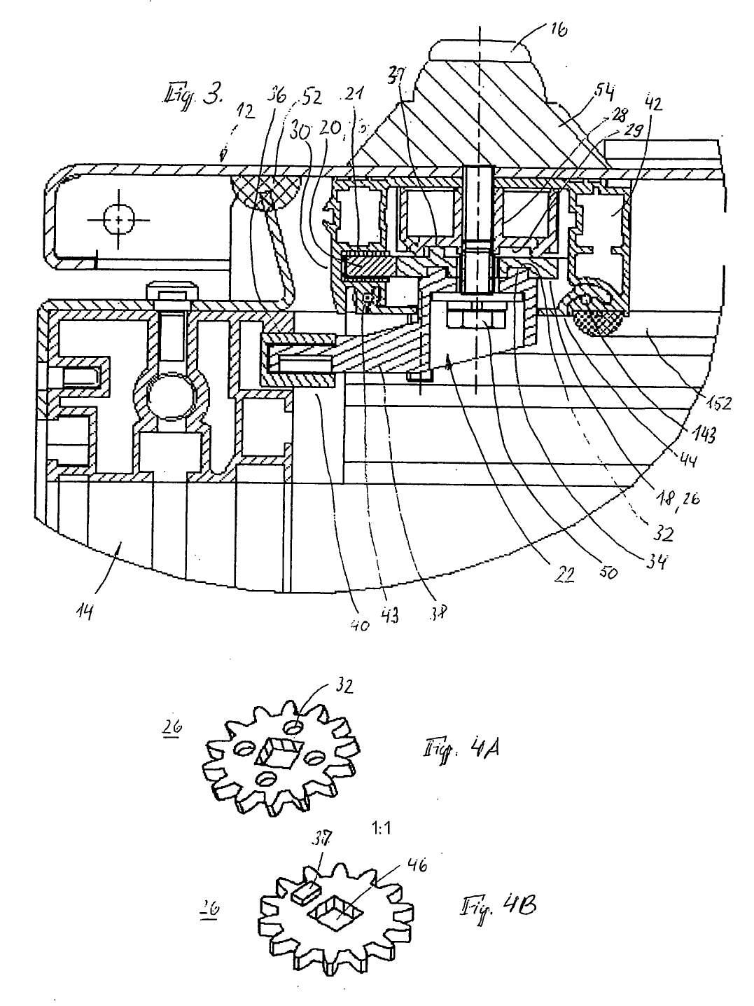

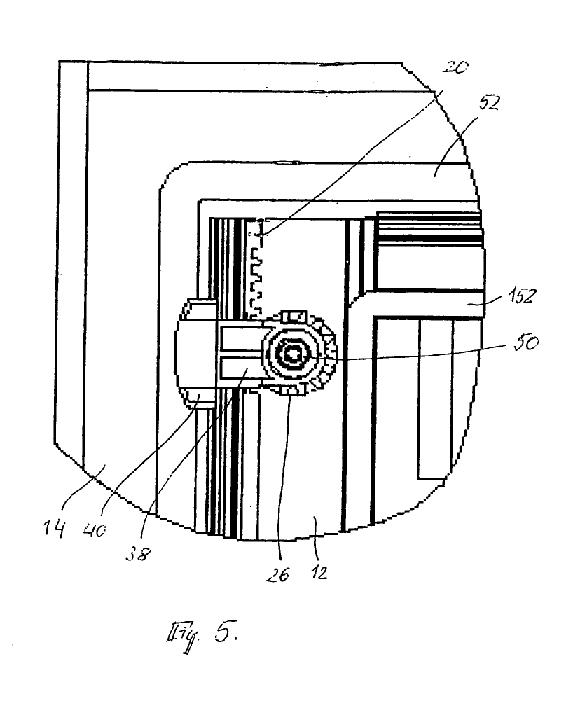

FIG. 1 is an exploded, perspective view of a fastener 10 which serves for multiple locking of a door 12 of a cabinet 14. The fastener 10 has a drive toothed wheel 18 which is connected to an actuation member such as a handle lever 16 according to FIG. 3 so as to be rigid against rotation, this actuation member being supported in the door 12. The drive toothed wheel 18 engages with a lock rod 20 which is supported in the door so as to be displaceable axially and which is provided with teeth on one side. Further, lock elements 22 which are coupled with the lock rod 20 are held in the door so as to be rotatable. A driven toothed wheel 26 which is connected to the lock element 22 so as to be rigid against rotation and which engages with the teeth 24 of the lock rod 20 serves in each instance to couple the lock rod 20 with each lock element 22 and is held on the door 12 so as to be rotatable—see the bearing designated by 28.

The teeth 24 of the toothed rod 20 can be whole or, as is shown in FIG. 2, partial, i.e., can comprise toothing portions 24, 124, 224, 324, and so on. One of these portions, e.g., portion 324, meshes with the drive toothed wheel 18, while the rest of the portions 24, 124, 224 mesh with driven toothed wheels 26 of different rotary lock elements 22.

By its lifting movement, the toothed lock rod 20 transmits the rotational movement of the drive toothed wheel 18 to the toothed wheels 26 of the driven side which are connected to the lock elements 22 in a positive engagement and/or frictional engagement. The guide of the toothed rod 24 can be held in an extruded profile 30 by separate guide parts made of metal (e.g., diecast zinc) or plastic (injection molded part) or by a shaped out portion 35.

The toothed wheel 18 driven by the hand lever 16 can also carry a lock element 22 at the same time, but it is simpler to spatially separate the drive and the driven toothed wheel 26—see the end of the driveshaft which lies below the driven part (opening 45) and is designated by reference number 41 in FIG. 1. The positive engagement between the lock element 22 and the toothed wheel 18 and 26, respectively, can be achieved, for example, in that the toothed wheel 26 has bore holes or recesses 32 into which projections 34 of the lock element 22 fit. Accordingly, the connection of the toothed wheel 26 to the driven side of the locking rod 24 for generating the rotational movement at the fastener lock 22 is carried out without additional intermediate members and is therefore particularly compact and tamper-proof.

Therefore, the arrangement in its entirety is very narrow so that the door leaf is substantially available for other purposes, e.g., for ventilation openings required for temperature control.

The lock element 22 can comprise a bent and/or shaped sheet-metal lug which can be swiveled in behind the housing contour or cabinet frame contour 36 by rotation. Alternatively, the lock element can also be made from a shaped or injection-molded plastic lug or metal lug 38 as is shown in FIG. 3. A shaped part 40 made of plastic or another material having good sliding properties can be arranged on a lug 38 of this kind and can then be swiveled in behind a housing contour or cabinet frame contour, e.g., contour 36, by rotating it.

The metal profile or plastic profile 30, which also supports the toothed rod 20, can be a substantially shaped sheet-metal part with a substantially U-shaped cross section 42. This cross section encloses not only the lock rod but also the toothed wheel 18 or toothed wheels 26. This U-shaped profile can advantageously be closed by a cover 44 that can be placed thereon to ensure that it is tight against dust, for example. The driven toothed wheels and drive toothed wheels advantageously have the same shape and have, for example, a center square opening 46 which makes possible a rotatable bearing support on a round mandrel 48 of the bearing part 28 on the one hand, but is also suitable on the other hand as a receptacle for a square for connecting to a hand lever 16 so as to be rigid against rotation.

The toothed wheel 26 and lug 38, which are connected in a positive engagement by projections 34 of the lug 38 which can be received in recesses 32 of the toothed wheel 26, are held axially by means of a cap screw 50 which can be received in a threaded bore hole 49 formed by the mandrel 48.

Friction is reduced and the risk of damage to the counterbearing or bearing part 28 of the lock element 22 is eliminated by using a shaped part which is made of plastic or other materials having good sliding properties and which is attached to the metal carrier part of the fastener lock. In contrast, the use of a bent, shaped sheet-metal lug that can be swiveled in behind the housing contour by rotation until it covers the latter to the maximum extent (rotated by 90°) often has the disadvantage that it causes extensive friction resistance on the one hand and on the other hand enables only small pull-in paths and is accordingly less suited for doors having thick sealing strips 52.

Given suitable material properties, the fastener lock 22 can also be manufactured entirely from plastic or another suitable material.

Accordingly, the long stop curvature of the shaped part 40 according to FIG. 1 ensures that a large pull-in path, which comes about, e.g., due to sealing strips 52, 152 during the closing process in which the sealing strips are compressed, is realized with relatively small rotating forces.

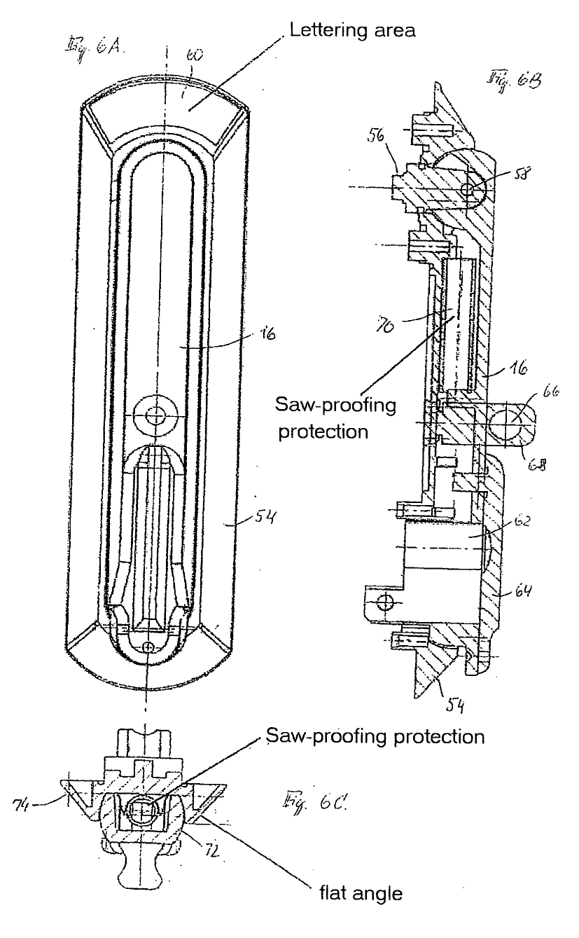

A swivel lever 16 which can be folded into a trough 54 arranged on the door serves as actuation member (see FIGS. 6a, 6b and 6c which show a top view, a sectional view and a cross-sectional view of the lever actuation arrangement).

The swivel lever 16 is supported on a driveshaft 56 so as to be swivelable around an axis 58 extending perpendicular to the driveshaft axis. The driveshaft 56 forms, or carries at its end facing inward, a square on which the drive toothed wheel 18 that is provided with a square hole 46 can be arranged in a positive engagement so that the drive toothed wheel 18 can be rotated, e.g., by 90° or more when rotating the swiveled out lever 16 around the axis of the driveshaft 56. In this way, the rod 20 is displaced and at the same time drives driven toothed wheels 26 in such a way that the latter rotate in turn, e.g., by 90°, and a tongue fastener 38 which is arranged on the driven toothed wheels 26 is rotated out of a release position parallel to the rod into a position, perpendicular to the rod at 90°, in which it engages behind the frame contour 36 of the cabinet.

In many applications it is desirable to indicate to the user the rotating direction of the actuation lever 16 that the user must select in order to open and close the fastener. A lettering area 60 indicated in FIG. 6a can be used for this purpose.

In many applications, particularly outdoors, unauthorized persons should be prevented from opening the cabinet. Therefore, it is usually useful to make the hand lever 16 lockable, for example, by means of a cylinder lock 62 which is arranged at the end of the hand lever 16 and whose cam engages behind a portion of the trough when the cylinder lock is in the locked position. The keyway may be protected by a cover 64. Additional security can be achieved by means of a padlock which can be inserted through an opening 66 of a lug 68. The lug extends through the hand lever 16 proceeding from the trough part and prevents the hand lever 16 from being folded out of the swiveled in position when the padlock is fitted through it. Saw-proofing protection 70 is provided in order to prevent this safeguard from being bypassed by sawing through the lever between the lug 68 and the hinge 58. This saw-proofing protection 70 comprises a pipe or the like which is made of a hard material and which can be glued into or rotatably supported in the reverse-trough-shaped cross section 72 of the hand lever 16, possibly also subsequently. In order to make it more difficult to grip the trough with pliers or the like, this trough has flat angles in its side walls 74 which makes it difficult to apply pliers because the jaws of the pliers would slip off.

The cover 44 of the U-shaped profile 30 has holes 45 to allow the base part 39 of the lug 38 to pass through (see FIG. 3). FIG. 3 also shows that the toothed rod 20 is held in special guide strips 21 made of plastic.

The cover 24 can be fixed in the U-shaped profile 42 by screws 43, 143. A protuberance 37 on the toothed wheel 18, 26 can serve to limit the rotational path, and a stop for the protuberance can project into a circular groove 29 formed by the bearing 28.

For the sake of compactness and strength, the toothed rack is supported (e.g., in the U-shaped profile) in such a way that it comes to rest between the door edge and the toothed wheel axis. Accordingly, the toothed rod is also particularly protected by the door bevel and the housing contacting the latter.

### COMMERCIAL APPLICABILITY

The invention is commercially applicable in switch cabinet construction.

While the foregoing description and drawings represent the present invention, it will be obvious to those skilled in the art that various changes may be made therein without departing from the true spirit and scope of the present invention.

### REFERENCE NUMBERS

10 fastener
12 door
14 cabinet
16 actuation member, handle lever, hand lever, swivel lever
18 drive toothed wheel
20 lock rod
21 guide part, guide strip
22 lock element
24, 124, 224, 324 teeth, toothing portions
26 driven toothed wheel
28 bearing part, counterbearing
29 circular groove
30 metal profile or plastic profile
32 notch, recess
34 projection
35 shaped out portion
36 housing contour or cabinet frame contour
37 protuberance
38 carrier part, plastic lug, metal lug, tongue fastener
39 base part
40 shaped part
41 driveshaft
42 U-shaped cross section
43, 143 screws
44 cover
45 holes
46 square opening, square hole
48 round mandrel
50 cap screw
49 threaded bore hole
52, 152 sealing strips
54 trough
56 driveshaft
58 axis
60 lettering surface
62 cylinder lock
64 cover
66 hole
68 lug
70 saw-proofing protection
72 cross section
74 side wall

What is claimed is:

1-19. (canceled)

20. A fastener for multiple locking of doors or wall portions in housings or cabinets, particularly for outdoor use, comprising:
a lockable actuation member such as a handle lever and further comprising a drive toothed wheel which is connected to said actuation member supported in a door so as to be rigid against rotation and which engages with a lock rod which is supported in the door so as to be displaceable axially and which has teeth on at least one side;
one or more lock elements which is/are held in the door so as to be rotatable or swivelable and which is/are coupled with the lock rod; and
for each lock element, a driven toothed wheel, which is connected to the lock element so as to be rigid against rotation and which engages with the toothing of the lock rod, being held on the door in a rotatable manner in order to couple the lock rod with the lock element or lock elements.

21. The fastener according to claim 20, wherein the lock rod which is supported so as to be displaceable axially is guided in a plurality of separate metal guide parts or plastic guide parts.

22. The fastener according to claim 20, wherein the lock rod, which is supported so as to be displaceable axially, is guided in an elongated metal profile or plastic profile.

23. The fastener according to claim 22, wherein the lock rod is so guided near the edge of the door.

24. The fastener according to claim 20, wherein a lock element is arranged on the driven toothed wheel and, optionally, the drive toothed wheel so as to be rigid against rotation.

25. The fastener according to claim 20, wherein the lock element comprises a bent and/or shaped sheet-metal lug which can be swiveled in behind a housing contour or cabinet frame contour by rotation.

26. The fastener according to claim 20, wherein the lock element comprises a shaped or injection-molded plastic lug or metal lug which can be swiveled in behind a housing contour or cabinet frame contour by rotation.

27. The fastener according to claim 20, wherein the lock element comprises a metal carrier part such as bent and/or shaped sheet-metal lugs or injection-molded plastic lugs or metal lugs on which a shaped part made of plastic or another material with favorable sliding properties is arranged and which can be swiveled in behind a housing contour or cabinet frame contour by rotation.

28. The fastener according to claim 27, wherein the shaped part which is arranged on the lock element for engaging behind a housing contour or cabinet frame contour has a curved contour which enables a long closing path when loaded by closing forces.

29. The fastener according to claim 20, wherein the lock element is made exclusively from plastic or another material with good sliding properties and can be swiveled in behind a housing contour or cabinet frame contour by rotating.

30. The fastener according to claim 20, wherein the lock element comprises a carrier part enclosing a shaped part that can be swiveled in behind a housing contour or cabinet frame contour by rotating, and in that the lock element, in its entirety, is made of plastic or of a metal part with coating of a material with good sliding properties.

31. The fastener according to claim 22, wherein the metal profile or plastic profile has a substantially U-shaped cross section which encloses the lock rod and toothed wheels.

32. The fastener according to claim 31, wherein the U-shaped profile can be closed by a cover which can be placed thereon.

33. The fastener according to claim 20, wherein the actuation member comprises a swivel lever that can be folded into a trough arranged on the door.

34. The fastener according to claim 33, wherein the trough comprises saw-proofing protection made of hard material.

35. The fastener according to claim 34, wherein the saw-proofing protection can also be retrofitted into the inner contour of the handle lever.

36. The fastener according to claim 35, wherein the saw-proofing protection is a cylindrical pin of hard material which is supported in the handle lever so as to be rotatable around the cylinder axis.

37. The fastener according to claim 33, wherein the trough comprises a lettering surface for displaying the rotating direction or other writing and/or symbols such as company logos.

38. The fastener according to claim 33, wherein the trough has shallow sloping outer side walls.

39. The fastener according to claim 20, wherein the lock rod is guided in such a way that it lies between the door frame and the toothed wheel.

40. The fastener according to claim 39, wherein the lock rod is guided in a U-shaped profile.
